(19) United States
(12) Patent Application Publication
(10) Pub. No.: US 2017/0290732 A1
(43) Pub. Date: Oct. 12, 2017

(54) Low pressure suction treatment incorporating measurement of tissue characteristics

(71) Applicant: HLD Healthy Life Devices Oy, Helsinky (FI)

(72) Inventors: Kalle Palomäki, Helsinki (FI); Steven Basta, Menlo Park, CA (US)

(73) Assignee: HLD Healthy Life Devices Oy, Helsinki (FI)

(21) Appl. No.: 15/481,726

(22) Filed: Apr. 7, 2017

Related U.S. Application Data
(60) Provisional application No. 62/319,839, filed on Apr. 8, 2016.

(51) Int. Cl. A61H 9/00

(52) U.S. Cl. CPC A61H 9/00; A61H 9/0057; A61H 9/005; A61H 2009/0064; A61H 2201/5087; A61H 2201/5058; A61H 2230/655; A61H 2201/50

(57) ABSTRACT

Method for assessing and preferably ameliorating the symptoms of a medical condition, optionally lymphedema, comprising obtaining a preferably both electrically powered and portable treatment apparatus capable of contacting, via a treatment head, a target area on the skin of a patient and introducing low-pressure suction thereto, wherein the apparatus, preferably the treatment head thereof, contains at least one sensor element to measure at least one physiological characteristic regarding the tissue underlying the target area of the patient, preferably indicative of fluid content thereof, and applying the treatment apparatus to the patient to measure said at least one physiological characteristic. A treatment apparatus for executing the method is presented.

### PRIORITY

This application claims priority of the provisional application U.S. 62/319839 which was filed on Apr. 8, 2016 and the contents of which is incorporated herein by reference.

### FIELD OF THE INVENTION

The present invention generally relates to medical methods. Especially, however not exclusively, the invention pertains to treatment of head and neck area lymphedema utilizing an apparatus producing low pressure suction on a target area of a patient and incorporating a sensor for measuring tissue characteristics such as fluid content.

### BACKGROUND

Lymphedema refers to a medical condition where lymphatic system comprising lymphatic vessels for carrying lymph fluid towards the heart is functioning inadequately, which causes fluid retention and tissue swelling. Such condition triggered by lymphatic dysfunction may be inherited due to initially inferior number or nature of lymph nodes or channels in the body, or caused by trauma.

Most typically the lymphedema occurs at limbs, but also incidents of head and neck lymphedema are known, which may be due to radiation treatment or surgical operations performed for treating associated cancer, for example.

Treatment of lymphedema is difficult and genuinely permanent results are seldom achieved without really extreme measures such as surgery.

Nevertheless, the symptoms may be relieved and condition at least momentarily improved by various means such as compression gear including garments, bandages and a related therapy called as ‘intermittent pneumatic compression’ therapy (IPC). Also appropriate physical exercises and skin care may be used to reduce the magnitude of lymphedema through stimulation of the lymphatic system and related supporting measures.

A so-called CDT (complete decongestive therapy) incorporating a multitude of different sessions and related measures involving skin stretching, use of compression bandaging, exercises, skin care, etc., which are repeated during an active phase of the treatment extending over several months, has also been developed to fight the lymphedema. After the active phase, maintenance activities shall still be daily executed to reduce the risk of swelling and other effects from returning.

As being alluded to hereinbefore, also more radical treatments such as a number of surgical procedures have been suggested and utilized. Obviously, the applicable surgical measures such as vascularized lymph node transfers (VLNT), grafting of lymph vessels, or lymphaticovenous anastomosis (LVA) are not typically adopted as the primary or first solution as they may be physically exhausting for the patients, contain additional risks, require considerable medical resources, induce remarkable costs and generally are, as most of invasive surgical operations, susceptible to various complications and side effects.

Notwithstanding the multiple, mutually quite different existing treatments that have been developed to treat and fight the effects of lymphedema, there still exists room for novel measures that at least momentarily relieve the detrimental effects thereof.

In particular, with head and neck area lymphedema (HNL) targeting e.g. face, mouth and/or neck of a patient, which is relatively common side effect of cancer treatment, the use of most obvious, convenient and affordable therapy methods such as compression garments is either practically impossible or at least extremely impractical.

Lymphatic drainage is one option which can benefit patient suffering from lymphedema, especially the kind of lymphedema affecting limbs. In lymphatic drainage, the lymphatic system is being activated. Lymphatic system includes such elements as lymphatic vessels that carry fluid called lymph, lymph nodes, associated organs, such as the spleen and the thymus. Lymphatic drainage is naturally done when muscles contract and relax, thus moving the lymph in the lymphatic vessels. Lymphatic drainage can be done manually by gently massaging the skin tissue in order to active the lymphatic system, i.e. manual lymphatic drainage (MLD), but is difficult to perform to head and neck region. Manual lymphatic massage typically requires a massage therapist to perform the procedure. Self-massage is also possible, however, can be exhaustive for an inexperienced person and difficult to perform effectively.

The diagnosed occurrences of HNL are considered rarer than other forms of lymphedema. However, in many ways HNL is analogous with more typical limb, e.g. arm or leg, lymphedema. The lymphatic load exceeds the capacity of lymphatic system and causes tissue inflammation and fibrosis, scarring, chronic swelling, fullness, pitting, etc. What is particularly troublesome, HNL may deteriorate the communication skills and general mobility of patients quite radically as e.g. their vision may be impaired and speech may become slurred. Further, respiratory and swallowing problems may arise. Clearly, e.g. facial lymphedema is also a major cosmetic problem.

It is evident that subjecting head and neck type areas to therapeutic surgical operations is both risky and complex, while the use of e.g. compression wrapping or kinesiotaping is difficult already from the standpoint of mere aesthetic or cosmetic issues not forgetting the related challenges in terms of maintaining the necessary movability of various body parts or preventing them from blockage with reference to e.g. nose, ears, mouth, or eyes.

Yet, in many cases medical conditions such as the aforesaid lymphedema or generally fluid content are difficult to diagnose or measure accurately. Quite commonly diagnosis as well as the assessment of therapy outcome is merely ocular or by palpation. Accordingly, an experienced therapist may succeed in detecting the condition at relatively early stage but typically detection occurs regrettably late and more exact monitoring of the medical condition or e.g. therapy results also remains a challenge.

### SUMMARY

The objective is to provide a method for measuring and treating conditions such as head and neck area lymphedema so as to provide at least temporary relief from the symptoms thereof while still preferably alleviating or overcoming one or more problems of the various prior art solutions.

Therefore, according to an embodiment, a method for assessing and preferably ameliorating the symptoms of a medical condition, optionally head and neck area or other area lymphedema, comprises

obtaining a preferably both electrically powered and portable treatment apparatus capable of contacting, via a treatment head, a target area on the skin, e.g. in the head, neck or other region, of a patient and introducing low-pressure suction, i.e. negative pressure flow, thereto, wherein the apparatus, preferably the treatment head thereof, contains at least one sensor element to measure at least one physiological characteristic regarding the tissue underlying the target area of the patient, preferably indicative of fluid content thereof, and

applying the treatment apparatus to the patient and measuring said at least one physiological characteristic prior to, upon and/or after treatment.

In preferred embodiments, the method further comprises:

configuring the treatment apparatus so as to introduce predefined, advantageously, pulsating pressure variation to a suction opening arranged at the treatment head, and

applying the suction opening of the treatment head on the target area while the treatment apparatus is on and providing the suction effect corresponding to the configuration, wherein the suction effect is preferably adjusted, optionally automatically by the apparatus, based on the measurement result.

In one further embodiment, an electrically powered and preferably portable treatment apparatus comprises a treatment head for contacting a target area on the skin, e.g. in the head, neck or other region, of a patient and introducing low-pressure suction thereto, where the apparatus, preferably the treatment head, contains at least one sensor element to measure at least one physiological characteristic regarding the tissue underlying the target area of the patient, preferably indicative of fluid content thereof, and further wherein the apparatus is preferably configured to adapt the suction based on the measurement result. In various embodiments, said configuring may include determination of at least one feature selected from the group consisting of: size of the opening at the treatment head, shape and/or dimensions of a treatment cup located at the treatment head, used treatment cup among multiple options of different material, shape, opening and/or dimensions, pulse duration, duty cycle, signal period, signal (repetition) frequency, pulse pressure, minimum, maximum or optimum duration of subjecting the treatment head to an area at a time, and minimum, maximum, or optimum duration of a treatment session. The beginning or end of any aforesaid duration may be optionally indicated audibly, tactilely (e.g. vibration) and/or visually to the patient or other operator of the apparatus during use for guidance.

In various embodiments, the apparatus may incorporate a central unit and a functionally connected treatment head that is preferably configured as hand-held by the patient or other operator of the apparatus. The connection may be established via a hose between the unit and head. The internal wall of said hose may define an air duct between a pressure chamber of the central unit and opening of the treatment head preferably provided by a treatment cup of the head. Further, an electrical connection between the two may be established via electrical wiring or wirelessly e.g. via electromagnetic coupling. The hose may transport gaseous matter, typically air, and thus cause the pressure pulsation due to a pulsating pumping action executed by pumping mechanism of the central unit. The central unit may include a vacuum pump for the purpose. In some embodiments, a fan could be alternatively utilized.

In various embodiments, said applying incorporates maintaining the portion, such as a cup, of the treatment head defining the opening substantially in contact, typically skin contact, with location at least partly defining the target area for a predefined time period, which may optionally refer to duration of few seconds, or e.g. about 3-5 pulsations.

Thereafter, the head may be re-positioned to a new location that may optionally overlap with the previous one. Such procedure may be continued until the target area as a whole has been treated at least once. In some embodiments, the treatment may be alternately directed to the same locations constituting the target area, e.g. as a repeated treatment pattern of several (sub-)areas with potentially overlapping portions, until a predefined overall period set for a treatment session, for instance, has lapsed.

The application technique in terms of motion may include stationary treatment. In stationary treatment, a certain target area or location, i.e. ‘sub-area’ therewithin in case the overall target area is too large for treatment by the treating head at a time (very typical scenario), is subjected to the low pressure suction treatment at a time by maintaining the treatment head thereon for some time, e.g. the aforementioned period of few seconds or few pulsations, prior to switching over to a next location. The switch over thus involves lifting the treatment head first away from the skin contact prior to moving it.

Alternatively or additionally, a so-called lift & twist-type technique may be utilized. While a certain location is treated and the treatment head is lifted from the skin, simultaneous rotating, or ‘twisting’, action is performed.

Alternatively or additionally, substantially continuous sliding type treatment technique may be applied by moving the treatment head over the locations of the target area while maintaining the contact of the treatment head. As one variation, ‘knitting’ style sliding with a twist motion may be tried.

As a further option, a hybrid approach may be selected implying keeping the treatment head stationary relative to one location accommodating the treatment head while during the switchover to a next location the contact is still maintained instead of lifting the head away. As being mentioned above, the subsequent location may overlap with the previous one.

In various embodiments where switchover between the locations of stationary treatment occurs, at least the two subsequent areas may have some overlap, e.g. about 20-50% overlap.

The utility of the present invention arises from a variety of factors depending on each particular embodiment thereof. In many cases even substantially immediate relief of the symptoms of concerned medical condition such as head and neck area lymphedema may be generally obtained by the suggested therapeutic method applying a low pressure suction apparatus. The generated pulsation generally stretches and generally mobilizes the skin, therefore stretching fascia and affecting the related structures of myofascia (i.e. soft tissue manipulation), thus typically making additional clearance below it and reducing the related pressure subjected to tissues, organs, veins, lymphatic vessels, etc., while further activating them and e.g. the lymphatic system in general. The treatment may also yield various other advantageous effects described herein. In addition to negative/low pressure, i.e. suction, the pulsation may introduce certain amount of positive pressure to the tissues considering e.g. the areas opposite or adjacent to the target area under suction, or even to the target area itself due to the undulating nature of the pulsation and resulting skin motion. Accordingly, some benefits of positive pressure may be realized as well.

With the suggested therapeutic procedures, the symptoms related to head and neck lymphedema such as the swelling, puffiness and fibrosis associated with head and neck areas may be reduced, the drainage of the lymph may be enhanced, pain may be relieved, range of motion improved, skin elasticity increased and general condition of the patient may improve as well as reduction of other symptoms. As a positive derivative effect, ambulation may be facilitated as well as respiration or swallowing problems reduced in addition to various other beneficial impacts.

Yet, the condition may with some patients improve also in a longer term, even permanently in some cases, although in most cases, the suggested treatment is preferably given more or less regularly, e.g. repeated once a week or every second week, to ascertain the permanency of the effect thereof.

A number of different sensors may be included in the treatment apparatus for providing information on the physiological characteristics of the skin tissue and/or subcutaneous tissue beneath it underlying the target area of the treatment head or of generally interest as there may be sensor(s) in the apparatus external to the treatment head. The obtained measurement data may be indicative of e.g. tissue/body fluid or water content. The wetness or hydration of tissue areas or volumes may be determined, for instance, based on the frequency responses of tissue underlying the sensor(s) when there are e.g. reference values available indicative of healthy or e.g. edematous tissue. The measurement data may facilitate diagnosis and follow-up of different medical conditions e.g. by an operator of the apparatus. In some embodiments, the data may be stored locally at the apparatus and/or remotely (the apparatus may contain a data interface such as a memory card interface, wired data interface such as a serial bus or a wireless data interface such as Bluetooth™, Bluetooth low energy, NFC (near-field communication), cellular or wireless LAN type interface) to enable delayed or remote inspection of measurement results by specialists, for instance. Different statistics may further be established based on the gathered measurement data.

The data or quantity/property derived based on the measurement, e.g. bioimpedance, may be indicated to the user e.g. audibly, tactilely and/or visually (via display, indicator light(s), etc.). The data may be utilized in automatically or manually, i.e. based on user input via the user interface, adapting the function of the apparatus such as suction parameters (e.g. pulse duration, signal period, oscillation frequency, and/or strength).

The embodiments of the present invention are considered both non-invasive and safe. The apparatus or generally equipment used to execute the treatment is affordable, portable/compact, reliable, quiet and easy to service or use either by a patient or separate operator. The user, either being the patient himself/herself or dedicated operator, is not required to take extensive training to be able to apply the apparatus although at least basic understanding of human lymphatic system and operation of the apparatus is naturally considered advantageous in favor of the effectiveness of the therapy.

Accordingly, the therapy may be provided flexibly at different premises such as the home of a patient, at a physical therapist, or at some other desired location. There is no need to visit a doctor, hospital or some specialized therapy center to receive the treatment, which may facilitate the life of the patient considerably in terms of reduced travelling and associated cost, and gained time savings among other factors.

Finally, use of the apparatus is practically completely painless as the pulsation pressure may be adjusted to suit each use scenario such that the effect of the treatment is achieved while the suction effect remains moderate only causing gentle draft and pull type stretch sensations on the skin in contrast to different prior art methods and apparatuses, the effect of which is at least partly based on harsh, mechanical skin stretching and actually pinching activity due to the use of gripping elements such as rollers, which may be rather painful on sensitive swollen and potentially infected skin.

Relying on an apparatus according to an embodiment of the present invention may in many cases turn out advantageous also to the operator in contrast to e.g. manual therapy. The elbows, wrists, and hands of the operator may be spared from fatigue and pain, which are commonly induced by lengthy days of manual therapy.

Various other advantages will become clear to a skilled person based on the following detailed description.

The expression “a number of” refers herein to any positive integer starting from one (1), e.g. to one, two, or three.

The expression “a plurality of” refers herein to any positive integer starting from two (2), e.g. to two, three, or four.

The terms “first” and “second” do not denote any order, quantity, or importance, but rather are used to distinguish one element from another.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objectives and advantages thereof, may be best understood from the following description of specific embodiments when read in connection with the accompanying drawings.

### BRIEF DESCRIPTION OF THE DRAWINGS

FIG. 1 illustrates schematically an embodiment of a treatment apparatus in accordance with the present invention.

FIG. 2 illustrates schematically an embodiment of a treatment apparatus in accordance with the present invention.

FIG. 3 illustrates embodiments of a treatment cup of the treatment head in connection with the treatment apparatus in accordance with the present invention.

FIG. 4 illustrates embodiments of a sealing part of the treatment head in accordance with the present invention.

FIG. 5 depicts first use scenario of low pressure suction apparatus in treating the neck of a patient.

FIG. 6 depicts second use scenario of low pressure suction apparatus in treating the cheek of a patient.

FIG. 7 is a flow diagram disclosing an embodiment of a method in accordance with the present invention.

### DETAILED DESCRIPTION

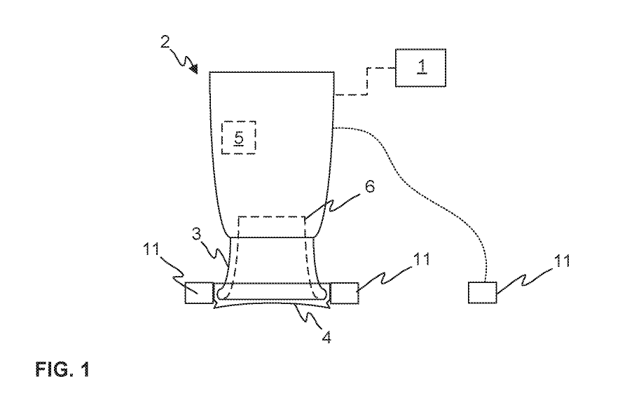

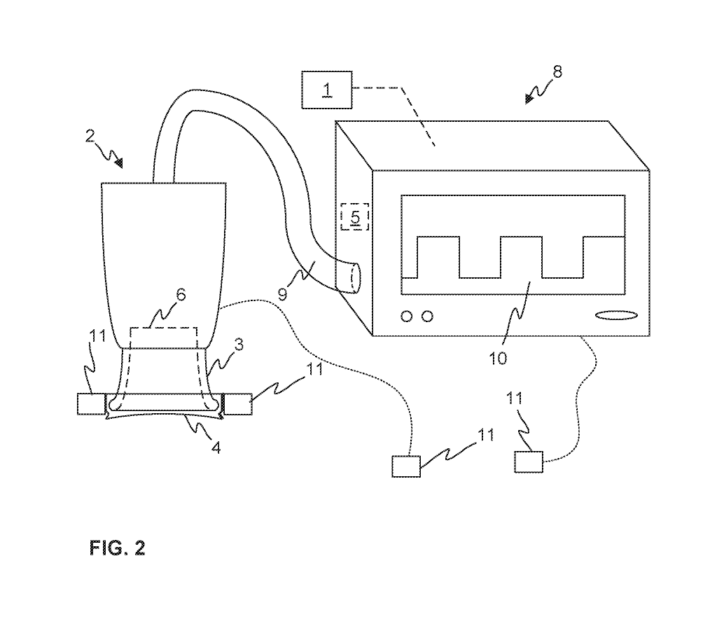

With reference to FIGS. 1 and 2, two embodiments of a treatment apparatus, or ‘device’, for use in connection with a therapeutic method in accordance with the present invention are illustrated.

Embodiments of the treatment apparatus comprise a treatment head 2, a central processing unit 1, a treatment cup 3, a sealing part 4, low pressure chamber 6 and means for producing the low pressure in the low pressure chamber 5. The central processing unit 1 may be arranged in connection with the treatment head 2 or in connection with a central unit 8 as shown in FIG. 2. The low pressure chamber 6 and the means for producing low pressure in the low pressure chamber 5 are shown schematically by dashed lines in FIGS. 1 and 2. The means for producing the low pressure 5 (negative pressure flow/suction effect), e.g. with a vacuum pump or a fan, may be in the treatment head 2 or in the central unit 8 in which case the means for producing the low pressure 5 is arranged in connection with the treatment head 2, e.g., by a hose 9. There may be a display in the treatment head 2 and/or 10 in the central unit 8. The central unit 8 may further incorporate an interface for an external display. In some embodiments, the features of a central unit 8 could even be combined with the treatment head 2 into an integral apparatus. In some embodiments, the pump or fan 5 could be included in the treatment head 2 while there is still provided a central unit 8 or similar element connected to the head 2 by a flexible element such as a cable or wiring for electricity and/or data transfer, for example. These types of embodiments would not obviously necessitate the use of a hose 9 for the suction flow between the elements 2, 8. When the pump or fan 5 is located within a common housing with the chamber 6, these two may still be connected via internal piping, hose(s) and/or duct(s), for example, for conveying the low pressure flow.

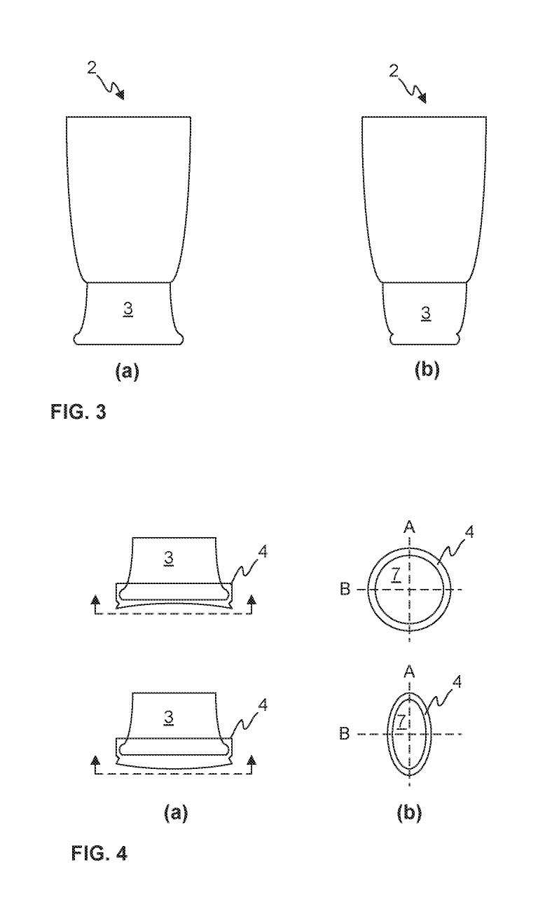

FIG. 3 illustrates two embodiments of the treatment cup 3, one end of which is arranged to be in connection with the low pressure chamber 6 and the other end of which is arranged to be pressed towards (meaning in this application a degree of contact or a magnitude of force from a gentle touch/contact to more intense pressing) the skin tissue to direct low pressure suction to the target area, typically skin tissue, thus producing a bulge in the skin tissue. The skin preferably refers herein to all skin layers i.e. epidermis, dermis, hypodermis or subcutis.

In FIG. 3, the end of the treatment cup 3 that is arranged to be pressed towards (typically against) the skin tissue is the lower end of the treatment cup 3. The treatment cup 3 is arranged to form a suction opening 7 (shown in FIG. 4(b)). FIGS. 3(a) and (b) illustrates two different shapes of treatment cups. There may also be other shapes and, thus, the examples in FIG. 3 are not shown to pose limitations to the treatment apparatus utilizable in connection with the method according to the present invention. The treatment cup 3 with an appropriate size, shape and/or material may be chosen based on the nature or size of the target area of the skin to be treated, for instance.

The treatment cup 3 may further comprise a sealing part 4 advantageously made of a flexible material and arranged at the end of the treatment cup 3 that is arranged to be pressed against the skin tissue and to adapt to the shape of the suction opening 7 formed by the treatment cup 3 and to seal the gap between the end of the treatment cup 3 and the skin tissue when the end of the treatment cup 3 is pressed against the skin tissue.

The sealing part 4 may be made of any suitable flexible material, such as polyurethane or elastomeric material. The use of other plastic materials and silicon material is also possible. At the sealing part 4, it is naturally also possible to use a suitable material that reduces or increases the friction between the sealing part 4 and the skin tissue, and/or a material that improves the sealing, depending on whether the objective is to achieve a good mobility for the treatment head or as high a friction force as possible. Mobility may also be increased by using a number rotating elements, such as rollers, which are in connection with the treatment cup 3. The rotating elements, in addition to the sealing part 4, may also provide sealing function between the skin and the treatment cup 3.

As the treatment head 2 of the treatment apparatus is moved against the patient's skin, most comfortably using a handle, the effect of the low pressure causes a fold of skin to be pulled up into the low pressure chamber 6.

FIG. 4 illustrates the shape of the sealing part 4 by side views from two substantially perpendicular directions. The sealing part 4, which is to be pressed against the skin tissue, is arranged to be concave in the direction of at least one of the main axes A or B of the suction opening 7 formed by the treatment cup 3.

In an embodiment of the treatment cup 3 of the treatment apparatus shown in FIG. 4(a), the surface of the sealing part 4 to be pressed against the skin tissue is concave in the direction of the main axis B of the suction opening 7 formed by the treatment cup 3. The shape of the suction opening 7 may be elliptical or oval or round (some examples are shown in FIG. 4(b)). However, these are not the only feasible embodiments but other shapes may be used as well.

In the above examples, the sealing part 4 is shown as a separate part fastened to the end of the treatment cup 3. The sealing part 4 may be a disposable part, which is detached after use and replaced by a new one in the beginning of the treatment of a new patient. Alternatively, the sealing part 4 may be reusable after washing or disinfecting. The fastening to the end of the treatment cup 3 may be achieved by means of various connections. At the end of the treatment cup 3, which is to be pressed against the patient's skin, there may be a flange in the radial direction, which is used for fastening the sealing part 4 made of a flexible material to its place. Thus, the schematically shown connection of the sealing part 4 in figures is not to be understood as a factor limiting the embodiments of the treatment apparatus used in connection with the method according to the present invention. It is also to be noted in this context that the sealing part or portion 4 may be formed as an integral part of the treatment cup 3, for instance.

In various embodiments, an opening for subjecting the target tissue such as skin to the suction may be defined by a treatment cup 3 (part or portion) of the treatment head 2. The treatment cup may be adaptable in size to best fit the shape of the treated body part. The adaptability may be implemented by a plurality of interchangeable cups of different size and/or by an adjustable cup. For example, the applicable size may range from about 10 or 20 mm to 80 or 90 mm in diameter depending on the dimensions and shape of the target area.

As a general rule, a largest cup considered suitable for the area may be selected. For instance, 60-80 mm size may be more suitable for the neck than for facial areas that benefit from using a smaller diameter cup and related opening.

The treatment apparatus is thus not restricted to the examples of the figures in any way, but the apparatuses may be varied entirely freely within the scope of the claims. Thus, it is clear that the invention is by no means restricted to any specific shape or dimension of the treatment cup 3 or other components, for instance, but the shape and/or dimensions of the different elements and parts of the invention may differ from one another freely between embodiments, if desired. The idea of the present invention may even be applied in connection with such treatment heads at which rotating elements such as rollers are employed, as mentioned hereinbefore.

The low pressure in the low pressure chamber 6 is advantageously produced by using the aforementioned vacuum pump. Necessary adjusting valves are also advantageously mounted in connection with the vacuum pump.

In addition, in case an embodiment of the treatment apparatus with a central unit 8 is utilized, the hose 9 may have a valve which is advantageously positioned near the low pressure chamber 6. The speed of the system may further be improved by using the hose 9 as a low pressure reservoir. Thus, higher or lower pressure may be achieved in the hose 9 compared to the pressure desired in the low pressure chamber 6, especially in case a central unit 8 is utilized. If, for example, change of pressure from 150 to 200 mmHg is desired, the pressure of the low pressure chamber 6 is 150 mmHg and if in the subsequent phase a pressure of 200 mmHg is desired, the pressure of the hose 9 may already be set for example to 500 mmHg, so that upon opening of the valve a pressure of 200 mmHg is achieved quickly in the low pressure chamber 6 and the valve may be closed. The valve may be arranged to be controlled by pulse width modulation for adjusting the low pressure in the low pressure chamber 6. In some embodiments the valve may control higher frequency oscillation (described in more detail hereinafter) produced in addition to lower frequency suction pulses. Alternatively, higher frequency oscillation could be produced by other element(s), such as electric motor or ‘vibrator’. In some embodiments, the oscillation could be at least temporarily solely produced (i.e. no simultaneous lower frequency pulsation).

Subsequently, if a pressure of 150 mmHg is again desired, in which case a pressure of for example 50 mmHg may be set in the hose 9 so that a change from 200 mmHg to 150 mmHg is quick. Furthermore, the low pressure chamber 6 when positioned against the target area (skin) may be either substantially sealed or it may have a controlled leakage, for example, through a small opening.

Reverting, in particular, to FIGS. 1 and 4, the treatment apparatus utilizable in the method according to the present invention preferably comprises a number of different sensors 11, one of which, for example, measures the composition of the skin tissue and/or underlying tissue, such as the fluid content and/or flow, fat content and/or oil content. For measuring the target characteristics, each sensor 11 may contain a number of exclusive or shared sensor, or ‘sensing’, elements such as electrodes or optical sensor elements. Separate sensors 11 may also be used for measuring fluid and fat contents. One sensor 11 may, for example, measure the raised skin (bulge) produced by the suction effect and one other sensor 11 may measure, for example, the suction force applied to the skin. The low pressure suction and specifically e.g. suction force may be adjusted according to the results of the measurements. Therefore, the apparatus may be adaptive and especially dynamically adaptive. Yet, the treatment apparatus may comprise a sensor 11 which measures the skin temperature. The sensors 11 may be designed for contactless or contact-based (e.g. contact electrodes) measurements.

Still, the apparatus may in some embodiments comprise a sensor 11 for measuring the skin's blood circulation, the measurements of which may be used to adjust of the operation of the treatment apparatus. Further, the adjustment may be based on measurement of transepidermal water loss and skin pH.

Each sensor 11 may be in connection with the treatment head 2 (e.g. removably or fixedly attached thereto) or communicate with the treatment apparatus through a wired or wireless connection, such as, for example, a radio frequency signal, infrared signal or the like. Thus, the sensors 11 may be an integrated or separate part of the treatment apparatus.

The apparatus may have at least one sensor that registers a signal given by the patient for increasing/decreasing the suction effect, based on which the adjustment of the suction may be done. The patient may thus give a signal to the sensor (for example, based on the pain experienced) and the sensor then relays to the apparatus the wish for the increase/decrease of suction efficiency. The sensor, such as a touch-registering sensor (e.g. a button), may be included in a user interface of the apparatus.

In one embodiment of the treatment apparatus, it may further comprise additional energy source(s) for warming the skin tissue and furthermore, means for automatically adjusting the energy source(s) to a set point value based on the measurements obtained by one or more sensors 11. Energy source may also be utilized to power up the apparatus for treating a patient.

Measurement techniques utilized in the embodiments of the treatment apparatus may include measurement of different sound frequencies, such as ultrasound and infrasound, techniques based on radiofrequencies and different wavelengths of light, i.e. optical measurement such as laser and infrared measurement, bioimpedance (bioelectrical impedance) spectroscopy or other bioimpedance measurement, magnetic resonance spectroscopy, Raman spectroscopy, nuclear magnetic resonance spectroscopy, microsensor mapping, heat camera imaging, or spectrophotometric intracutaneous imaging.

Indeed, at least one sensor 11 may be provided, e.g. on either or both sides of the cup 3 or sealing part 4 thereof, to measure water or generally fluid content. The measurement may thus be local and indicate localized or e.g. body segment localized property or quantity such as the amount of accumulated cell fluid or lymphedema of tissue underlying the target area.

In addition to the mere target area, i.e. area covered by the treatment head 3, 4, or underlying volume the measurements may be cover further area or volume adjacent thereto, depending on the configuration (positioning/spanned area or volume, type, etc.) of the used sensor(s) 11.

In some embodiments, the treatment apparatus may comprise sensors 11 that are wiredly or wirelessly connected thereto and may thus span a considerable larger or different, potentially remote, area/volume than that covered by e.g. the treatment cup 3 or part 4 defining the suction opening 7 of the treatment apparatus.

In some embodiments, the at least one sensor 11 may include at least two sensor elements such as contact electrodes, optionally e.g. four electrodes. There may be one electrode per sensor 11, for example, or several electrodes, e.g. an array of electrodes, may be considered to at least functionally belong to the same sensor 11.

Nevertheless, the electrodes may be configured to execute e.g. two-terminal or four-terminal sensing of bioimpedance or other parameter indicative of tissue fluid content, such as extracellular, intracellular, and/or total fluid content, and thus of potential lymphedema.

For instance, at least two electrodes may be current (driving) electrodes whereas at least other two electrodes serve as voltage (sensing) electrodes. In the case of two electrodes only, for example, both the electrodes may serve current while being used for sensing as well.

In some embodiments, only one electrode may suffice. For example, capacitive sensing may be performed using one or more electrodes.

The central processing unit 1, which may refer to e.g. one or more microcontrollers, microprocessors, signal processors and/or other circuitry, may be configured, in accordance with computer program instructions stored thereat (in integral or separate memory), to determine the selected properties or quantities, e.g. one or more indices of bioimpedance based on the sensor data typically obtained via a number of electrodes.

The bioimpedance measurement may be executed based on determining resistance to the current flow. From the obtained data, other information may be derived and estimated regarding e.g. fat level.

In some embodiments, single frequency, multi-frequency or spectroscopy type, i.e. broadband, measurements may be executed for determining the desired property/quantity such as bioimpedance and/or its constituents such as resistance and reactance. The used frequencies may vary between 0 kHz and 1000 kHz (more specifically e.g. 0-30 kHz), for example, depending on the type of the used sensors and the property to be determined. The desired frequency range of alternating drive current may be covered by a selected number of intermediate frequencies at which measurements are taken.

To diagnose different conditions, such as lymphedema, the obtained measurement results such as bioimpedance readings or quantities derived therefrom may be then compared with selected, typically prestored, threshold values to determine whether the presence of condition is likely or not.

Higher frequencies penetrate the cell membranes (which can be modelled as capacitors) better and therefore reach intracellular space and qualify for associated intracellular (fluid) measurements while lower frequencies may be typically used for mere extracellular space analysis.

In some embodiments, capacitive sensing may be applied for edema and particularly lymphedema determination. The capacitance measured may be proportionate to the dielectric constant of the skin and the subcutaneous tissue, which in turn indicates the water or fluid content thereof. Frequency or frequencies between e.g. 20 and 500 Hz may be applied in the measurements.

In some embodiments, elastic force of the skin/tissue and e.g. (edema) pressure thereof may be determined. Because of the negative pressure formed in the chamber 6, the internal pressure in the inter-tissue/intercellular space, in the blood vessels and the lymphatic vessels expands tissue volume and stretches and/or raises the skin, which is elastic. At first, the tissue pressure in the expanded point is lower than in the surrounding tissue space. The inter-tissue fluid/interstitial fluid, the blood and the lymph are transferred from the higher pressure towards the lower pressure and fill up the expanded volume. Thus the skin rises until equilibrium finally is reached because of the elastic force of the tissue. In the state of equilibrium, the forces caused by the elasticity of the tissue and the air pressure in the pressure chamber are of the same magnitude as the force of the tissue pressure. In the above mentioned event, the pressure and the pressure change can, based upon the signal given by a pressure sensor, be measured as a function of time and likewise, based upon the measurements of a range sensor, the rising of the tissue and/or skin is known as a function of time. The results of the measurements are transferred to the processing unit 1, where the data is saved and processed. Based upon these measurements, the unit 1 calculates the elastic force of the skin and/or the tissue and further the pressure or edema pressure of the skin and/or the tissue.

Accordingly, mechanical, physical and/or e.g. electrical characteristics of the skin and underlying subcutaneous tissue may be monitored by the embodiments of the present invention through introduction of necessary sensing hardware and logic in the apparatus.

In some embodiments of the treatment apparatus, the potentially automated adjustment of the low pressure suction and/or suction force is based on mechanical characteristics and/or electrical characteristics and/or structure and/or composition of the skin. Mechanical characteristics include strength, flexibility, elasticity and resilience etc. Electrical characteristics include, for example, capacitance, impedance, resistance, reactance and inductance.

In some embodiments, the apparatus may comprise a number of additional elements, which are configured to operate e.g. as energy sources (e.g. laser, ultrasound or infrasound emitter, etc.) for treating the tissue, such as for heating. The elements may be based on sound, light, radio frequency or electricity, for example, The measurements from one or more sensors may be then advantageously used for automatically adjusting the energy sources to the desired value.

In addition, the potentially automated adjustment of the apparatus may in one embodiment be based on measurements of the flow of lymphatic fluid. The associated measuring techniques for the flow of lymphatic fluid may be selected from known techniques, such as, but not limiting to, isotope clearance technique.

In one embodiment of the treatment apparatus, the adjustment may also be based on the measurement of the patient's experience of cutaneous pain. Based on the experience, either the patient him/herself, or the operator, or both together adjust the apparatus's running parameters. Skin characteristics, when mentioned in this text, also include the pain felt and experienced on the skin.

In an embodiment of the treatment apparatus, a computer program, as alluded to hereinbefore, guides in the application of the suction force by presenting the force level audibly and/or visually in the treatment head 2 and/or in the central unit 8 (e.g. via display 10 in case of visual information). Low pressure suction may be adjusted automatically using the computer program, and thus it is not necessary for the patient or operator to adjust the low pressure suction during the treatment. Advantageously, when the treatment force exceeds the permitted value, the program stops the apparatus or lowers the suction force.

The computer program may be utilized to calculate the target value of one or more on-going treatment forces, such as suction force, based on the measurements obtained and/or on the desired value of the suction pressure. Therefore, the apparatus also comprises sensor/sensors as mentioned hereinbefore for measuring one or more ongoing treatment forces, such as the level of the suction force. A computer program may be configured to automatically calculate and adjust the level of low pressure suction to the target value, based on the measurements obtained. The parameters/results of the measurements, which may be taken into account in determining the target value of the low pressure suction, include e.g. fluid content of the skin tissue, fat content of the skin tissue, the bulge i.e. the lift of the skin tissue (the size of the fold in the skin) and/or the skin temperature.

Furthermore, the computer program may be functionally connected to database, which contains the patient's treatment information. The database may be remote and hosted by a remote computer or computer system, which is accessed via a communications connection or network, e.g. the Internet. For the purpose the treatment may include a wired or wireless data interface, e.g. USB (Universal Serial Bus), Bluetooth™, NFC/RFID (Near-Field Communication/Radio Frequency Identification), cellular, wireless LAN (Local Area network) or wired LAN interface.

The computer program or at least part, such as few instructions, thereof may be provided on a non-transitory carrier medium such as a memory card or memory chip, or transferred as a wired or wireless signal.

In one embodiment of the treatment apparatus, it is desired to combine slow, pulsating low pressure to a faster impulse-like oscillation treatment. For instance, the oscillation treatment may be modulated by a pulsating low pressure treatment.

In one embodiment of the treatment apparatus, the treatment apparatus is arranged to provide to the low pressure chamber 6 simultaneously a pulsating low pressure treatment, which preferably has a frequency of below 5 Hz, and an oscillation treatment, which for its part, preferably has a frequency of more than 5 Hz. In other embodiment, the threshold frequency between low pressure pulses and high frequency oscillation may be different.

Moreover, a high frequency oscillation treatment may be particularly added to the suction phase of the low frequency pulsating low pressure treatment. The oscillation may extend over the whole duration of the low pressure pulse. In some embodiments, in addition to the duration of the pulse, the oscillation could be present also during the neutral portion of the signal period. In some embodiments, the duty cycle of 100% (i.e. continuous suction/pulse) may be applied, whereupon also the optional oscillation may be on all the time. High frequency in this instance may mean for example an impulse-like pressure change or oscillation with a frequency of more than 5, 10, 15 Hz or higher frequencies such as e.g. 90 Hz or even as high as 200 Hz. The hose 9 may be arranged in this case to be used as a pressure reservoir for accelerating pressure variations in the low pressure chamber 6.

When using the high frequency oscillation, higher frequencies affect the (skin) tissue closer to the surface of the skin while with lower frequencies the effect of the treatment ‘penetrates’ deeper into the tissue. Thus by varying the frequency of the high frequency oscillation, the depth of the effect of the treatment may be varied and problems at different depths of the (skin) tissue may be more effectively treated.

In an embodiment, the pulsation frequency may range from about 0.1 Hz to about 5 Hz, or occasionally even up to 10 Hz depending on the particular embodiment of the apparatus (supported frequencies). For instance, it may be about 0.5 Hz that corresponds to a 2 second signal period and 1 second pulse duration with 50/50 duty cycle. The suction on the skin tissue when the treatment cup 3 is facing the skin is naturally introduced during the associated on-time (i.e. 1 second in case of 2 second total signal period with 50/50 duty cycle).

Preferably the configured frequency is user-adjustable via a user interface of the apparatus. The user interface may include a number of control input elements in the form of a touch display, touch pad, button, mouse, Scrollpoint™, roller, voice input interface, keypad, etc. for the purpose.

Accordingly, the UI (user interface) may include e.g. a display and/or audio response interface (typically buzzer or loudspeaker) for data visualization and feedback provision towards the apparatus operator. The operator may be the patient himself/herself or other person who preferably has adequate medical and technical skills to operate the apparatus in sufficient fashion.

Typical pressure (suction, i.e. negative pressure) of the treatment apparatus may preferably be of the order of about 80 mmHg, falling e.g. within a range from about 5, 10 or 30 to about 250 mmHg, or even up to about 350 mmHg or higher, e.g. about 500 mmHg. As being clear based on this disclosure, the negative pressure is preferably user-adjustable or—selectable in at least most embodiments. However, use of fixed (user non-adjustable) pressure and potentially other fixed parameters is possible in some embodiments of the apparatus as well. Such embodiments could be targeted to certain very specific use scenarios or applications, for example.

In some embodiments, the operator of the device is provided, via the UI of the device, a pressure setting and/or pressure readings in predetermined, optionally user-selectable, units such as mmHg or pascal. Alternatively or additionally, e.g. a numeric value in a predetermined scale, e.g. between one and five or one and ten, without any particular units could be used for adjustments and/or indicated to the operator. One end of the scale could represent predetermined minimum suction or zero suction, whereas the other end (e.g. maximum number) could represent predetermined maximum suction. The apparatus manages the conversion between the user-indicated pressure and corresponding real pressure established.

Instead or in addition to numeric values, the pressure and/or other parameters could be indicated through other symbols, optionally using dot/circle, star, line, curve or rectangular shapes.

The order of magnitude of high frequency oscillation may range, for example, from about 2 to about 200 Hz, preferably at least from about 5 or 10 Hz to e.g. about 100 Hz.

In head and neck lymphedema, excessive lymph build-up occurs especially at or above the shoulder level.

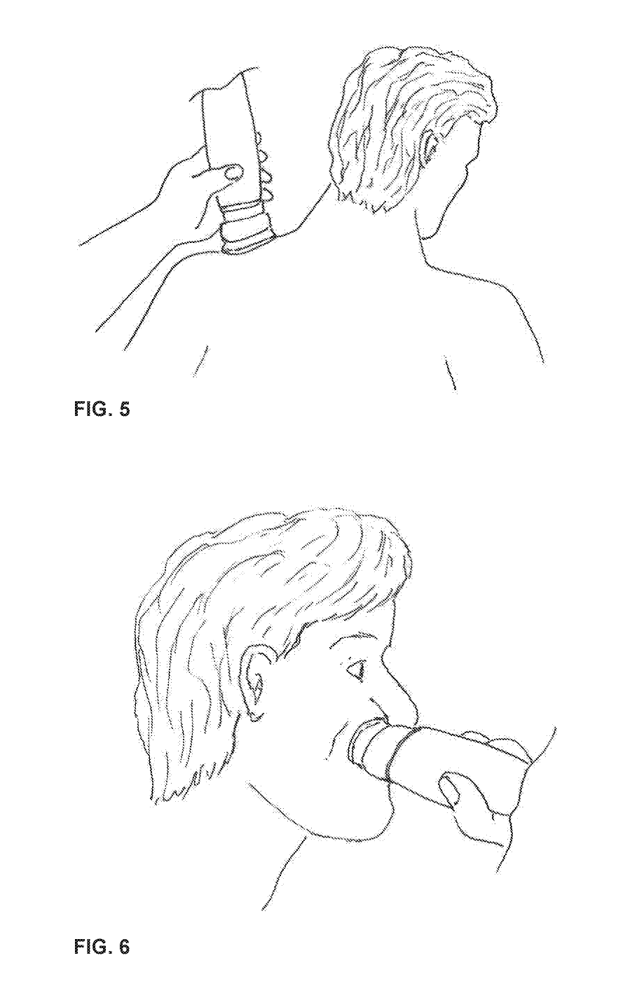

FIG. 5 thus depicts a first use scenario of low pressure suction apparatus in treating, in particular, the neck area of a patient. The patient may sit or stand in upright position during the treatment, for instance.

Optionally, lubricant such as massage oil may be initially smeared on a target area of the skin. Care shall be taken that the lubricant does not contain particles that could end up within the apparatus during the treatment to avoid clogging the internals thereof and related cleaning procedures.

The treatment head is located so that the associated contact portion, such as preferably replaceable treatment cup, is in close contact with the skin area to be treated, e.g. on the trapezius muscle (shown), spine, or e.g. sternum.

The diameter of an optimum cup generally varies between patients and from a treating technique to another, but in standard case it may range from about 60 mm to about 80 mm, for example. As an applicable basic rule, one could consider to select the largest suitable treating cup for each target area. Fastening of the treatment cup having regard to the rest of the treatment head may incorporate grooves (in the cup or head) and matching lips (in the head or cup, respectively), snap fastener(s), threads, magnets, frictional and/or pressure contact (e.g. based on the elasticity (enabling stretching) and/or roughness of the contacting surface(s) yielding tight, secure fit), or any combination of the above or other feasible attachment technologies providing e.g. sufficiently secure and airtight fit between the connected elements.

The treatment head/cup should be hold onto relatively lightly. The cup may typically be kept on the same location for about three to five pulsations, whereafter it may be moved to adjacent skin area with e.g. ⅓ overlap. The total number of locations, or spots, that are treated depends on the overall coverage of the treated condition, which typically defines the target area of treatment, as well as the size of the cup and related suction opening. The area may encompass from about one or two to ten locations, for instance.

Either stationary, sliding or hybrid technique may be applied having regard to the lifting of the treatment head during the movement thereof on the skin between the different treated areas. The general direction of motion may be sideways and/or from the top to the bottom (i.e. from the head towards the torso or shoulder line). Thus the overall duration of treating a certain area or spot at a time commonly ranges from about one or few seconds to few tens of seconds depending on the utilized pulse duration and duty cycle and thus the overall signal period.

Pulse length/duration may be about one second, for example, and the used pressure e.g. between 50-80 mmHg. Duty cycle may be about 50/50 (50%) between the pulse period and passive period, i.e. pulse-containing and neutral portions of the treatment signal, respectively, whereupon the overall repeating signal period comprising the pulse portion and neutral/passive portion covers two seconds. The duty cycle with two-second signal period may also be, e.g. 20/80 (20%) or 30/70 (30%) in which cases the pulse-containing portion lasts 0.4 or 0.6 seconds and neutral portion 1.6 or 1.4 seconds, respectively. The signal period may be varied preferably from a half to five seconds thus meaning pulsation frequency of 0.2 to 2 Hz. The high frequency oscillation additionally provided at least or exclusively during the pulse-containing period (1 second in case of duty cycle of 50/50 (50%) with a two-second signal period) may preferably be from 20-90 Hz.

One shall acknowledge the fact that also the neutral period (at least no low frequency suction) is usually treatment-wise important e.g. in a sense that during it the skin stretching stops and the skin recovers its relaxed position. The effectiveness of the treatment is in many respects due to the back-and-forth movement of the skin, not just due to suction-based stretching thereof.

FIG. 6 depicts a second use scenario of low pressure suction apparatus in treating the head and especially e.g. facial area, such as cheek, of a patient.

In the shown case, the treatment cup/head has been placed on a temporal area and the treatment direction may be towards the areas of underlying submandibular and/or cervical lymph nodes, for instance.

The used pulse duration may again be about 1 second, duty cycle 50% (thus rendering the overall signal period to two seconds) and pressure (suction) between about 5-350 mmHg, advantageously about 80-250 mmHg, and most advantageously about 80-120 mmHg, for example. The optimum treatment cup size is often a bit smaller than with neck treatments, thus typically falling between about 35 mm and 50 mm in diameter. Stationary technique may be preferred over the sliding or hybrid techniques on the sensitive facial areas, but also the latter may be tried.

The above parameters could be applied to other target areas such as forehead as well, starting the treatment from the location above the eye brows and continuing towards the cheek bones, for example.

Having regard to various embodiments, typically one therapy session lasts for about 10-60 minutes at a time. A treatment period may include multiple sessions, e.g. about 10 sessions. As mentioned hereinbefore, in many cases the obtained results are not necessarily permanent, whereupon the therapy should be regularly practiced even after a more intensive therapy period, e.g. once a week.

Considering the general direction of motion of the treatment head in the therapy sessions, one could conclude that typically the locations closer to the two subclavian veins may be treated prior to locations farther away therefrom, e.g. limb extremes, so that the main lymphatic channels are opened for the lymphatic flow first instead of trying to open the extreme conduits first while the flow is still blocked centrally.

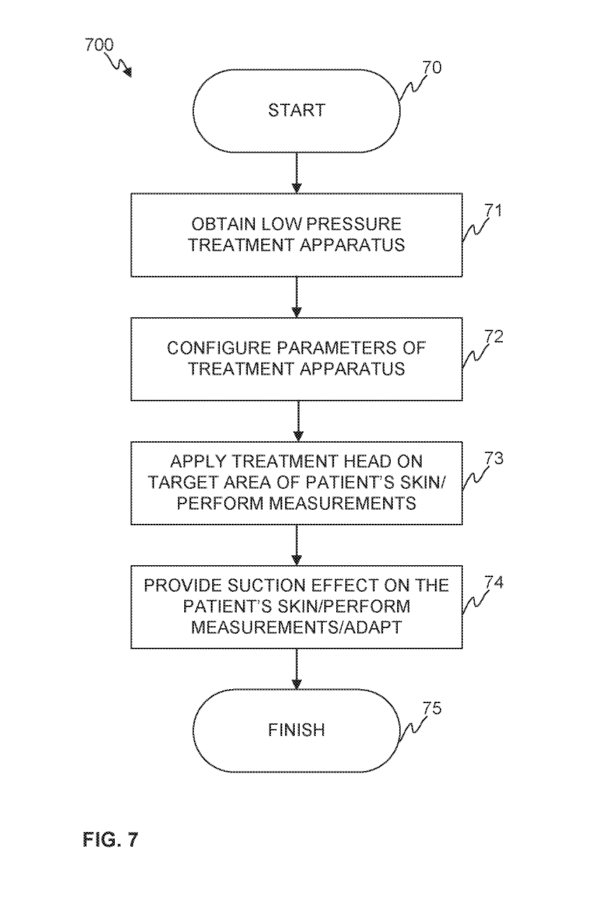

FIG. 7 is a flow diagram disclosing an embodiment of a method in accordance with the present invention.

Item 70 refers to a start-up phase. Decision to treat a patient in accordance with the principles of the present invention is made.

At 71, an embodiment of a treatment apparatus is obtained. It may be purchased, borrowed or rented, for example. Further gear, such as massage oil and treatment chair or table/platform may optionally be further acquired at this stage.

At 72, the apparatus and possible other equipment (e.g. chair/table) are configured, which may refer to adjusting, via the UI of the apparatus, desired parameters for the treatment including e.g. suction pressure, pulsation frequency, oscillation frequency, duty cycle, etc. A patient may himself/herself configure and subsequently utilize the apparatus. Alternatively, the apparatus may be operated by some other party, such as a professional operator such as a medical professional, a therapist, a nurse, a friend or a family member of the patient. Already for the configuration tasks, the apparatus may have to be turned on unless the configuration can be purely adjusted by using e.g. mechanical switches, sliders or other elements that continuously remember their state in contrast to e.g. touch pads or touch displays that have to be powered up first to register the user input. Measured characteristics may be optionally selected at this stage by the user via the UI of the apparatus. The associated sensor(s) may be configured or (re-)calibrated.

At 73, the treatment head is (re-)positioned on a target area or sub-area thereof to be treated, which usually involves placing the head, or in practice the contact part of the associated treatment cup or similar element, in contact with the skin of the patient. Depending on the nature of the treatment, stationary, sliding or hybrid application technique may be selected. Measurements may be executed. Based on the measurement results, treatment parameters such as suction characteristics (e.g. strength) may be determined.

At 74, the treatment is executed having regard to the target area by subjecting the area to the low pressure (suction) pulses and intervening neutral or passive periods. Measurements may be executed. Treatment parameters may be adapted accordingly responsive to the measurement results. Adaptation of e.g. suction may be manual (by the device operator) or executed automatically by the control logic of the apparatus.

In practice, items 73 and 74 are usually simultaneously and/or sequentially repeatedly executed during a treatment session. Accordingly, their mutual execution order may be considered to vary. The treatment head/cup at a certain location usually covers only a small sub-area of the overall target area at a time, whereupon the head shall be moved along a desired route on the skin to cover the target area in its entirety using a preferred application technique. The measurement results may be stored locally and/or transmitted forward to an external device or system for analysis or other purposes.

Method execution is ended at 75. The suction and the apparatus in general may be turned off. Alternatively, at least some measurement results and/or other gathered statistics concerning the treatment, e.g. pressure, pulse characteristics, or various durations, may be inspected via a display or other feasible element of the treatment apparatus itself, or outputted therefrom via an available data communication interface either wirelessly or wiredly. The data may be transferred to a near-by device or a remote system, optionally via the Internet, for storage, inspection (e.g. visualization) and/or analysis. The external device or system may host a database for storing data from a number of treatment apparatuses. The patient may be instructed to drink water to prevent dehydration.

In some variations of the treatment apparatus described herein, the treatment head and related elements, e.g. suction cups thereof, could be configured for enabling substantially contactless operation in addition to or instead of contact-based therapy. During the contactless therapy, the treatment head could be merely hovered close to the target area without actually contacting the skin, for instance. The apparatus could be provided with audible, tactile and/or visible guidance element such as loudspeaker, buzzer, vibration element, indicative lamps (e.g. LEDs) and/or a display, optionally touchscreen, The guidance element could indicate, in real-time fashion, current and/or proper distance between the target surface (e.g. skin) and the treatment head. In contact-based treatment, the cup/flexible element of the treatment head inherently provides such guidance for maintaining a proper distance (in that case, contact) between the head and target surface.

In addition to or instead of measuring or treating e.g. lymphedema such as head and neck lymphedema or other lymphedema, various embodiments of the present apparatus and method may be applied for measuring, treating or at least ameliorating the symptoms of many other conditions including, but not limited to, cording, myofascial pain, fibrotic tissues, scars, neuropathic pain, diabetic neuropathy, chemotherapy-induced neuropathy, nerve function disorders, postoperative conditions, fibromyalgia or Lyme disease.

Accordingly, the optimum treatment settings such as pulse duration, signal period, oscillation parameters (e.g. frequency) and/or suction strength, may be selected condition-specifically for obtaining best or generally desired treatment result in each use scenario. The apparatus may contain a plurality of user-selectable presets for treating different conditions.

1. A method for assessing and preferably ameliorating the symptoms of a medical condition, optionally head and neck area or other area lymphedema, such as reducing swelling, reducing pain, improving range of motion and/or improving swallowing, comprising
obtaining a preferably both electrically powered and portable treatment apparatus capable of contacting, via a treatment head, a target area on the skin, optionally in the head or neck region, of a patient and introducing low-pressure suction thereto,
wherein the apparatus, preferably the treatment head thereof, contains at least one sensor element to measure at least one physiological characteristic regarding the tissue underlying the target area of the patient, preferably indicative of fluid content thereof, and
applying the treatment apparatus to the patient and measuring said at least one physiological characteristic.

2. The method of claim 1, comprising configuring the treatment apparatus so as to introduce selected, advantageously pulsating pressure variation to a suction opening arranged at the treatment head, and
applying the suction opening of the treatment head on the target area while the treatment apparatus is on and providing the suction effect corresponding to the configuration.

3. The method of claim 1, wherein the treatment head comprises a preferably replaceable treatment cup for contacting the skin of the patient, preferably without substantial clearance, further wherein a proper cup is selected from a plurality of cups responsive to the characteristics and/or location of the target area to be treated.

4. The method of claim 1, wherein the diameter of the suction opening of the head, preferably of the cup thereat, falls within the ranges of about 10 mm through about 85 mm.

5. The method of claim 2, wherein the pulsating pressure variation comprises low pressure pulses substantially in the range from about half a second to two seconds, preferably about one second, in duration and/or from about 5 mmHg to 350 mmHg, advantageously from about 80 mmHg to 250 mmHg, in strength.

6. The method of claim 1, wherein an overall signal period that is then repeated contains a pulse period with suction effect and temporally adjacent passive period substantially introducing no suction, wherein the relationship between the two is optionally determined by a preferably user-adjustable duty cycle parameter of the apparatus.

7. The method of claim 2, wherein the pulsating pressure variation includes, in addition to low frequency pulses, simultaneous higher frequency oscillation, preferably falling within a range of about 5 to about 100 Hz.

8. The method of claim 1, wherein the treating head is maintained at a certain location of the target area for a duration covering about 3-5 pulses at a time.

9. The method of claim 1, wherein two successively treated locations of the target area overlap, preferably about 20-50%.

10. The method of claim 1, wherein a number of same locations are alternately treated during a single treatment session.

11. The method of claim 1, wherein the application technique of the head is, in terms of motion, stationary, sliding or a hybrid between the two involving maintaining the head at a certain location for some time while also sliding the head substantially in skin contact between locations.

12. The method of claim 1, wherein lubricant, optionally massage oil, is initially applied to the target area.

13. The method of claim 1, wherein the apparatus comprises a central unit connected to the treatment head at least by a hose.

14. The method of claim 1, comprising spanning several treatment sessions distributed over time, optionally substantially regular sessions or at least about 5-15 sessions, preferably of at least about 10 minutes in duration and/or at least about once a week.

15. The method of claim 1, wherein based on the measurement result the function of the apparatus is adapted optionally having regard to suction or other treatment parameter, preferably automatically.

16. An electrically powered and portable treatment apparatus comprising a treatment head for contacting a target area on the skin, e.g. in the head, neck or other region, of a patient and introducing low-pressure suction thereto, where the apparatus, preferably the treatment head, contains at least one sensor element to measure at least one physiological characteristic regarding the tissue underlying the target area of the patient, preferably indicative of fluid content thereof, and further wherein the apparatus is preferably configured to adapt the suction based on the measurement result.
